(19) United States
(12) Patent Application Publication
(10) Pub. No.: US 2018/0155571 A1
(43) Pub. Date: Jun. 7, 2018

(54) AIR-DRYING TYPE WATER-BORNE PAINT COMPOSITION

(71) Applicant: NIPPON PAINT CO., LTD, Tokyo (JP)

(72) Inventors: Takahiro UJII, Neyagawa-shi (JP); Soichiro YAMASHITA, Neyagawa-shi (JP)

(73) Assignee: NIPPON PAINT CO., LTD, Tokyo (JP)

(21) Appl. No.: 15/576,326

(22) PCT Filed: May 25, 2016
(86) PCT No.: PCT/JP2016/065496

§ 371 Date: Nov. 22, 2017

(30) Foreign Application Priority Data
May 26, 2015 (JP) 2015-106403

(51) Int. Cl. C09D 163/00; C09D 179/02; C09D 5/02; C09D 123/08

(52) U.S. Cl. CPC C09D 163/00; C09D 179/02; C08K 5/5415; C09D 5/027; C09D 123/0853; C09D 5/022

(57) ABSTRACT

Provided are: a two-pack air-drying type water-borne paint composition comprising a first agent and a second agent, wherein the first agent contains a water-borne epoxy-based amine resin (A) that has at least one amino group selected from the group consisting of a primary amino group and a secondary amino group in a molecule thereof and has an amine equivalent of 500 to 2000, and the second agent contains an epoxy resin emulsion (B); and a water-borne epoxy-based amine resin (A) that can be used for the paint composition.

### TECHNICAL FIELD

The present invention relates to a curable water-borne paint composition.

### BACKGROUND ART

A curable paint composition has been used in paints of various use applications, and a typical example thereof is an anti-corrosive paint that is intended to be used for imparting an anti-corrosive coating film to an object of interest. Conventionally, a two-pack organic-solvent-based paint that is composed of a main agent containing an epoxy resin, and a polyamine-type curing agent has been primarily used as an anti-corrosive paint. However, from the viewpoint of reduction of environmental load, a switch from an organic solvent-borne paint to a water-borne paint has been keenly demanded. In recent years, under these circumstances, various types of water-borne paints have been developed and placed on the market.

For example, Japanese Patent No. 5246977 (PTD 1) discloses a water-borne epoxy resin primer that is compose of a main agent containing an epoxy resin emulsion and a curing agent containing an amine resin emulsion. The amine resin emulsion contained in the curing agent is an emulsion prepared by dispersing an epoxy adduct-type modified polyamine resin, in which an epoxy group is added to an amino group, in an aqueous medium.

### CITATION LIST

### Patent Document

### PTD 1: Japanese Patent No. 5246977

### SUMMARY OF INVENTION

### Technical Problems

For example, when a water-borne paint is painted outdoors, a coating film that is not completely cured yet is sometimes exposed to rainfall. Therefore, a water-borne paint is required to have “water resistance before complete curing”. The term “water resistance before complete curing” refers to water resistance of a coating film at an initial stage of curing, specifically a coating film that is not cured completely but is cured to such an extent that the coating film does not have stickiness any more. When the water resistance before complete curing of an applied coating film is poor, if the coating film is exposed to rainfall before the coating film is completely cured, cracking or blistering may occur in the coating film. If cracking or blistering occurs in a coating film, performance to be imparted to an object of interest by forming the coating film (e.g., anti-corrosion properties in the case where an anti-corrosive coating film is intended to be formed) on the object may be deteriorated. The water-borne epoxy resin primer as disclosed in Patent Literature 1 still has room for improvement in water resistance before complete curing.

An object of the present invention is to provide a curable water-borne paint composition that makes it possible to form a coating film having excellent water resistance before complete curing.

### Solutions to Problems

The present invention provides an air-drying type water-borne paint composition and a water-borne epoxy-based amine resin that can be used for the paint composition as mentioned below.

[1] A two-pack air-drying type water-borne paint composition comprising a first agent and a second agent,

wherein the first agent contains a water-borne epoxy-based amine resin (A), the water-borne epoxy-based amine resin (A) having at least one amino group selected from the group consisting of a primary amino group and a secondary amino group in a molecule thereof and having an amine equivalent of 500 to 2000, and

the second agent contains an epoxy resin emulsion (B).

[2] The air-drying type water-borne paint composition according to [1], wherein the water-borne epoxy-based amine resin (A) is of a water dispersion type.

[3] The air-drying type water-borne paint composition according to [1] or [2], wherein the water-borne epoxy-based amine resin (A) is an amine-modified product of an epoxy resin, and

the epoxy resin has an epoxy equivalent of 700 to 3800.

[4] The air-drying type water-borne paint composition according to any one of [1] to [3], wherein the water-borne epoxy-based amine resin (A) comprises a water-borne epoxy-based amine resin (A1) having an amine equivalent of 500 to 1300 and a water-borne epoxy-based amine resin (A2) having an amine equivalent of 1400 to 2000.

[5] The air-drying type water-borne paint composition according to [4], wherein a mass ratio of the water-borne epoxy-based amine resin (A1) to the water-borne epoxy-based amine resin (A2) is 8/2 to 2/8.

[6] The air-drying type water-borne paint composition according to any one of [1] to [5], wherein the water-borne epoxy-based amine resin (A) is a neutralization product in which an amino group of an epoxy-based amine resin is neutralized with an acid.

[7] The air-drying type water-borne paint composition according to [6], wherein a neutralization ratio in the neutralization is 20 to 60%.

[8] The air-drying type water-borne paint composition according to any one of [1] to [7], wherein the epoxy resin emulsion (B) is an emulsion of a bisphenol A-type epoxy resin having an epoxy equivalent of 150 to 1200.

[9] The air-drying type water-borne paint composition according to any one of [1] to [8], wherein at least one of the first agent and the second agent further contains an emulsion (C) of a non-curable resin.

[10] The air-drying type water-borne paint composition according to [9], wherein the emulsion (C) of a non-curable resin is an emulsion polymerization product of a monomer having a polymerizable unsaturated bond.

[11] The air-drying type water-borne paint composition according to [10], wherein the monomer having a polymerizable unsaturated bond comprises ethylene and vinyl acetate.

[12] The air-drying type water-borne paint composition according to any one of [1] to [11], wherein at least one of the first agent and the second agent further contains an alkoxysilane compound (D).

[13] A water-borne epoxy-based amine resin (A) having at least one amino group selected from the group consisting of a primary amino group and a secondary amino group in a molecule thereof and having an amine equivalent of 500 to 2000.

### Advantageous Effects of Invention

According to the present invention, it becomes possible to provide a curable water-borne paint composition from which a coating film having excellent water resistance before complete curing can be formed.

### DESCRIPTION OF EMBODIMENTS

The water-borne paint composition according to the present invention is a two-pack curable air-drying type paint composition that includes a first agent containing a water-borne epoxy-based amine resin (A) and a second agent containing an epoxy resin emulsion (B). The water-borne paint composition according to the present invention can be formed into a cured coating film through a curing reaction between the water-borne epoxy-based amine resin (A) and the epoxy resin emulsion (B) which is caused as the result of mixing of the first agent with the second agent. The water-borne paint composition according to the present invention can be used suitably as an anti-corrosive paint (including a heavy-duty anti-corrosive paint) and the like.

### <Water-Borne Epoxy-Based Amine Resin (A)>

The water-borne epoxy-based amine resin (A) to be contained in the first agent is a water-borne epoxy-based amine resin that has at least one amino group selected from the group consisting of a primary amino group and a secondary amino group in a molecule thereof and has an amine equivalent of 500 to 2000. The term “water-borne” as used herein refers to “water-soluble” or “water dispersion type”. The water-borne paint composition according to the present invention may contain at least two types of water-borne epoxy-based amine resins (A).

The water-borne paint composition according to the present invention in which a combination of the above-specified water-borne epoxy-based amine resin (A) with the epoxy resin emulsion (B) is used can form a coating film having excellent water resistance before complete curing. The term “water resistance before complete curing” as used herein refers to water resistance of a coating film at an initial stage of curing, specifically a coating film that is not cured completely but is cured to such an extent that the coating film does not have stickiness any more. When the water resistance before complete curing of an applied coating film is poor, if the coating film is exposed to rainfall before the coating film is completely cured, cracking or blistering may occur in the coating film. If cracking or blistering occurs in a coating film, performance to be imparted to an object of interest by forming the coating film (e.g., anti-corrosion properties in the case where an anti-corrosive coating film is intended to be formed) on the object may be deteriorated. The water-borne paint composition according to the present invention which can be formed into a coating film having excellent water resistance before complete curing is particularly effective for application onto an outdoor object which has a possibility of being exposed of rainfall after the object is painted and before the resultant coating film is cured completely.

The water-borne paint composition according to the present invention can improve flexibility (toughness) of the resultant completely cured coating film, resulting in improvement in impact resistance of the coating film (in the present specification, the term “completely cured coating film” is used as a term that means a completely cured or almost completely cured coating film, for the purpose of distinguishing the “completely cured coating film” from a coating film to be assessed with respect to water resistance before complete curing thereof). In addition, the water-borne paint composition according to the present invention can improve adhesion (cohesiveness) of a completely cured coating film to an underlying base (e.g., an existing (old) coating film, a surface of an object to be painted). The improvement in adhesion to an underlying base (e.g., an existing coating film, a surface of an object to be painted) can lead to improvement in anti-corrosion properties of the coating film. The term “existing coating film” as used herein refers to an old coating film that was formed in the past on an object that is to be painted with the water-borne paint composition according to the present invention and has been used already. The existing coating film may be a coating film formed from the water-borne paint composition according to the present invention or a coating film formed from another paint composition. A water-borne paint composition having good adhesion to an existing coating film is useful for formation of a new coating film on a surface of an object of interest including an existing coating film or an application of a refinish coating onto a surface of an object of interest including an existing coating film.

In order to form a crosslinked structure through a curing reaction between the water-borne epoxy-based amine resin (A) and the epoxy resin in the epoxy resin emulsion (B), the water-borne epoxy-based amine resin (A) preferably has at least two amino groups selected from a primary amino group and a secondary amino group. The number of the amino groups may be equal to or greater than 3, or equal to or greater than 4.

The water-borne epoxy-based amine resin (A) is preferably of a water dispersion type, from the viewpoint of water resistance before complete curing and water resistance of a completely cured coating film. When the water-borne epoxy-based amine resin (A) is of a water dispersion type, homogeneous mixing of the water-borne epoxy-based amine resin (A) with the epoxy resin emulsion (B) can be achieved easily, and rapid progression of the reaction between the water-borne epoxy-based amine resin (A) and the epoxy resin in the epoxy resin emulsion (B) can be prevented to achieve moderate reaction progress. As a result, a water-borne paint composition having a long pot life can be obtained. More specifically, when the water-borne epoxy-based amine resin (A) is of a water dispersion type, the water-borne epoxy-based amine resin (A) is not easy to be in contact with the epoxy resin in the epoxy resin emulsion (B) in the water-borne paint composition that is not subjected to painting yet even after mixing of the first agent with the second agent. As a result, the reaction between the water-borne epoxy-based amine resin (A) and the epoxy resin in the epoxy resin emulsion (B) does not proceed in the water-borne paint composition even after mixing of the first agent with the second agent, leading to good storage properties and coating properties of the water-borne paint composition. On the other hand, after painting of the water-borne paint composition, a dispersion medium (e.g., water) is evaporated, and therefore the water-borne epoxy-based amine resin (A) can be in contact with the epoxy resin in the epoxy resin emulsion (B) more easily. Therefore, the curing reaction can proceed even at ambient temperature (25° C. or a temperature around 25° C.) or a temperature lower than ambient temperature to form a coating film.

The water-borne epoxy-based amine resin (A) has an amine equivalent (i.e., an equivalent of an amino group) of 500 to 2000, preferably 600 to 1900, more preferably 800 to 1800. The water-borne paint composition according to the present invention may contain two or more types of water-borne epoxy-based amine resins (A) having different amine equivalents from each other. When a water-borne epoxy-based amine resin (A) having an amine equivalent that falls within the above-mentioned range is used, it becomes possible to impart excellent water resistance before complete curing to the resultant coating film. The use of a water-borne epoxy-based amine resin (A) having an amine equivalent that falls within the above-mentioned range is also advantageous for improvement in impact resistance and/or adhesion to an underlying base (e.g., an existing coating film, a surface of an object to be painted) of a completely cured coating film. If the amine equivalent is less than 500, there is such a tendency that the water resistance before complete curing of the resultant coating film becomes poor and the water resistance of a completely cured coating film also becomes poor. If the amine equivalent exceeds 2000, a phase separation between the epoxy-based amine resin and water occurs, and the water-borne epoxy-based amine resin (A) may not be produced. By adjusting the amine equivalent of the water-borne epoxy-based amine resin (A), characteristics of the water-borne paint composition and physical properties of the coating film can be controlled.

The term “amine equivalent” as used herein refers to a molecular weight (in terms of a resin solid content) of the water-borne epoxy-based amine resin (A) per one primary amino group when the water-borne epoxy-based amine resin (A) has a primary amino group (including the case where the epoxy-based amine resin (A) contains both of a primary amino group and a secondary amino group), and also refers to a molecular weight (in terms of a resin solid content) of the water-borne epoxy-based amine resin (A) per one secondary amino group when the water-borne epoxy-based amine resin (A) has no primary amino groups. The amine equivalent of the water-borne epoxy-based amine resin (A) can be determined from used amounts of raw materials.

For example, the water-borne epoxy-based amine resin (A) may be one prepared by an amine modification of an epoxy resin (hereinafter, an epoxy resin that forms the water-borne epoxy-based amine resin (A) may be referred to as “a first epoxy resin”) (i.e., an aminated epoxy resin). A water-borne epoxy-based amine resin (A) prepared by the amine modification of the first epoxy resin is preferably a water-borne epoxy-based polyamine resin having at least two amino groups selected from the group consisting of a primary amino group and a secondary amino group. The term “epoxy resin” as used herein refers to a compound having at least one epoxy group (e.g., a glycidyl group) in a molecule thereof. The number of epoxy groups in the first epoxy resin is preferably 2 or more, more preferably 2. Specific examples of the first epoxy resin include a bisphenol A-type epoxy resin and a bisphenol F-type epoxy resin, and the first epoxy resin is preferably a bisphenol A-type epoxy resin. As the first epoxy resin, a combination of two or more types of epoxy resins may be used. The amine equivalent of the water-borne epoxy-based amine resin (A) can be controlled by adjusting a molecular weight of the water-borne epoxy-based amine resin (A) or the amount of the primary amino group and/or the secondary amino group to be introduced by the amine modification.

The first epoxy resin may be a resin in which a molecular weight is increased or the resin is modified by the chain extension utilizing a reaction of an active hydrogen-containing compound capable of reacting with an epoxy group with an epoxy group. Specific examples of the active hydrogen-containing compound include bifunctional compounds such as a dimer acid, a diamine and a polyether polyol. The first epoxy resin may also be a resin having a fatty acid added thereto. When a fatty acid is added, it becomes possible to introduce a soft component into the resin. In this case, flexibility and impact resistance of the completely cured coating film can be improved. It also becomes possible to modify (reduce) reactivity of the first epoxy resin by decreasing the number of sites to be amine-modified (i.e., the number of epoxy groups) through the addition of a fatty acid.

An epoxy equivalent of the first epoxy resin is preferably 700 to 3800, more preferably 800 to 3600, still more preferably 800 to 3500. The epoxy equivalent of the first epoxy resin falling within the above-mentioned range is advantageous from the viewpoint of improvement in water resistance before complete curing of a coating film, water resistance and anti-corrosion properties of the completely cured coating film. If the epoxy equivalent of the first epoxy resin is less than 700, there is such a tendency that water resistance before complete curing of the coating film is deteriorated. If the epoxy equivalent of the first epoxy resin exceeds 3800, a phase separation between the epoxy-based amine resin and water may occur and therefore the water-borne epoxy-based amine resin (A) may not be produced. The epoxy equivalent of the epoxy resin can be determined in accordance with JIS K 7236.

Specific examples of a method for the amine modification of the first epoxy resin include (1) a method in which a primary-amino-group-containing polyamine is added to the first epoxy resin and (2) a method in which a ketiminated amino-group-containing compound is added to the first epoxy resin. The epoxy-based amine resin (aminated epoxy resin) prepared by each of the above-mentioned methods is an epoxy-based polyamine resin having at least one primary amino group and/or at least one secondary amino group and a secondary hydroxyl group in a molecule thereof. A resin that is further modified by reacting a compound having a functional group (e.g., an epoxy group, an acid anhydride group, an acid halogen group, an isocyanate group, a (meth)acryloyl group) with some of the primary amino groups, the secondary amino groups and/or the hydroxyl groups in the epoxy-based polyamine resin may be used as the water-borne epoxy-based amine resin (A). When the thus produced water-borne epoxy-based amine resin (A) is used alone or in combination with another resin, it becomes possible to modify physical properties of the resultant coating film. The term “(meth)acryloyl” as used herein refers to at least one of methacryloyl and acryloyl.

More specifically, the above-mentioned method (1) is a method in which the primary amino group in the primary-amino-group-containing polyamine is reacted with the epoxy group in the first epoxy resin to form a secondary amino group, thereby producing the above-mentioned polyamine resin having the secondary amino group. Specific examples of the primary-amino-group-containing polyamine include diethylenetriamine, dipropylenetriamine, dibutylenetriamine and triethylenetetramine. Only one type of primary-amino-group-containing polyamine may be used, or a combination of two or more types of primary-amino-group-containing polyamines may be used.

More specifically, the above-mentioned method (2) is a method in which a ketiminated amino-group-containing compound is reacted with the first epoxy resin and then a ketimine group is hydrolyzed to form a primary amino group, thereby producing the above-mentioned polyamine resin having the primary amino group. In the reaction of the ketiminated amino-group-containing compound with the first epoxy resin, a secondary amine such as diethanolamine, methylethanolamine or diethylamine may be co-existed in the reaction system.

The ketiminated amino-group-containing compound can be produced by reacting a primary-amino-group-containing compound with a ketone. Specific examples of the primary-amino-group-containing compound include: a primary-amino-group-containing polyamine such as diethylenetriamine, dipropylenetriamine, dibutylenetriamine and triethylenetetramine; and aminoethylethanolamine, methylaminopropylamine and ethylaminoethylamine. Only one type of primary-amino-group-containing compound may be used, or a combination of two or more types of primary-amino-group-containing compounds may be used. Specific examples of the ketone include methyl ethyl ketone, acetone and methyl isobutyl ketone.

As mentioned above, the water-borne epoxy-based amine resin (A) preferably has at least two amino groups selected from the group consisting of a primary amino group and a secondary amino group. For example, the water-borne epoxy-based amine resin (A) has at least one (e.g., at least two) of the above-mentioned amino group at one end and has at least one (e.g., at least two) of the above-mentioned amino group at the other end.

The water-borne epoxy-based amine resin (A) may be a neutralization product produced by neutralizing an amino group in an epoxy-based amine resin (preferably an epoxy-based polyamine resin), which is produced by amine-modifying an epoxy resin, with an acid. This neutralization with an acid can be applied to, for example, a case where an epoxy-based amine resin produced by the amine modification of an epoxy resin is not a water-borne form and it is intended to convert the epoxy-based amine resin into a water-borne form.

The type of the acid and the neutralization ratio may be selected appropriately depending on the desired form of the water-borne epoxy-based amine resin (A) (e.g., a water-soluble form, a water dispersion type). Specific examples of the acid include acetic acid, formic acid, lactic acid and phosphoric acid. The term “neutralization ratio” as used herein refers to a ratio of the number of moles of amino groups to be neutralized with the acid to the total number of moles of amino groups in the epoxy-based amine resin, which is expressed in percentage. The neutralization ratio is preferably 20 to 60%, more preferably 20 to 55%. When the neutralization ratio falls within the above-mentioned range, it becomes possible to produce an water borne form, particularly a water dispersion type, of water-borne epoxy-based amine resin (A) easily.

The number average molecular weight of the water-borne epoxy-based amine resin (A) is preferably 1000 to 20000, more preferably 1500 to 10000, in terms of standard polystyrene as determined by gel permeation chromatography (GPC). When the number average molecular weight of the water-borne epoxy-based amine resin (A) falls within the above-mentioned range, homogeneous mixing of the water-borne epoxy-based amine resin (A) with the epoxy resin emulsion (B) can be achieved easily, and therefore a coating film having uniform hardness and therefore having uniform strength can be obtained. The number average molecular weight of the water-borne epoxy-based amine resin (A) falling within the above-mentioned range is advantageous from the viewpoint of improvement in water resistance before complete curing of the coating film, and impact resistance, water resistance, anti-corrosion properties and adhesion to an underlying base (e.g., an existing coating film, a surface of an object to be painted) of the completely cured coating film. By adjusting the molecular weight of the water-borne epoxy-based amine resin (A), it also becomes possible to control characteristics of the water-borne paint composition and physical properties of the coating film.

From the viewpoint of curability of the water-borne paint composition, water resistance before complete curing of the coating film, and impact resistance, water resistance and anti-corrosion properties of the completely cured coating film, the content of the water-borne epoxy-based amine resin (A) in terms of a solid content is preferably 5 to 95% by mass, more preferably 10 to 90% by mass (e.g., 10 to 50% by mass), relative to the whole solid content of the water-borne paint composition.

A ratio of the equivalent of the amino group in the water-borne epoxy-based amine resin (A) to the equivalent of the epoxy group in the epoxy resin in the epoxy resin emulsion (B) (hereinafter, the epoxy resin in the epoxy resin emulsion (B) may be referred to as “a second epoxy resin”) (i.e., an (epoxy group)/(amino group) ratio) is preferably 0.5 to 2.0, more preferably 0.6 to 1.7. If the equivalent ratio is less than 0.5, curability of the water-borne paint composition may be deteriorated. If the equivalent ratio exceeds 2.0, adhesion to an underlying base (e.g., an existing coating film, a surface of an object to be painted) or water resistance before complete curing of the resultant coating film may be deteriorated.

As mentioned above, the water-borne epoxy-based amine resin (A) may contain at least two types of water-borne epoxy-based amine resins (A) having different amine equivalents from each other. A preferred example of the case where at least two types of water-borne epoxy-based amine resins (A) having different amine equivalents from each other are used is a case where the water-borne epoxy-based amine resin (A) contains both a water-borne epoxy-based amine resin (A1) having an amine equivalent of 500 to 1300 and a water-borne epoxy-based amine resin (A2) having an amine equivalent of 1400 to 2000. When a combination of the water-borne epoxy-based amine resin (A1) and the water-borne epoxy-based amine resin (A2) is used, water resistance before complete curing of the coating film can be further improved.

From the viewpoint of water resistance before complete curing of the coating film, the amine equivalent of the water-borne epoxy-based amine resin (A1) is preferably 600 to 1300, more preferably 800 to 1300 (e.g., 1000 to 1300), and the amine equivalent of the water-borne epoxy-based amine resin (A2) is preferably 1400 to 1800, more preferably 1400 to 1700.

From the viewpoint of water resistance before complete curing of the coating film, a content ratio of the water-borne epoxy-based amine resin (A1) to the water-borne epoxy-based amine resin (A2) is preferably 8/2 to 2/8 by mass, more preferably 7/3 to 3/7 by mass.

The present invention also provides a water-borne epoxy-based amine resin (A) itself, which has at least one amino group selected from the group consisting of a primary amino group and a secondary amino group in a molecule thereof and has an amine equivalent of 500 to 2000. The water-borne epoxy-based amine resin (A) according to the present invention may contain two or more types of water-borne epoxy-based amine resins that belong to the water-borne epoxy-based amine resin (A). A specific example of the case where two or more types are contained is a case where two or more types of water-borne epoxy-based amine resins (A) having different amine equivalents from each other are contained, as is the case where the water-borne epoxy-based amine resin (A1) and the water-borne epoxy-based amine resin (A2) are contained.

The water-borne epoxy-based amine resin (A) according to the present invention can be used suitably as one of agents (a first agent) of a two-pack curable water-borne paint composition or as a component to be contained in the aforementioned one of agents. The other of the agents (a second agent) of the two-pack water-borne paint composition is or contains a compound having at least one (preferably at least two) functional group capable of reacting with the amino group of the water-borne epoxy-based amine resin (A) in a molecule thereof. From the viewpoint of water resistance before complete curing of the coating film, and impact resistance and adhesion to an underlying base (e.g., an existing coating film, a surface of an object to be painted) of the completely cured coating film, the second agent is desirably the below-mentioned epoxy resin emulsion (B). Alternatively, another compound such as a compound having at least one (meth)acryloyl group in a molecule thereof may be used as the second agent. Also in this case, a coating film having excellent water resistance before complete curing may be formed, as long as the water-borne epoxy-based amine resin (A) according to the present invention is used.

### <Epoxy Resin Emulsion (B)>

The epoxy resin emulsion (B) to be contained in the second agent is an epoxy resin emulsion (an emulsified epoxy resin) prepared by dispersing a second epoxy resin in an aqueous medium such as water. The epoxy resin emulsion (B) may be a forcibly emulsified one or a self-emulsified one. As the epoxy resin emulsion (B), a commercially available product may be used.

The second epoxy resin is preferably a compound having two or more epoxy groups in a molecule thereof. A specific example of the compound is a reaction product of a polyhydric alcohol or a polyhydric phenol with a halohydrin. Specific examples of the second epoxy resin include a bisphenol A-type epoxy resin, a halogenated bisphenol A-type epoxy resin, a novolac-type epoxy resin, a polyglycol-type epoxy resin, a bisphenol F-type epoxy resin, an epoxidized oil, 1,6-hexanediol diglycidyl ether and neopentyl glycol diglycidyl ether. As the second epoxy resin, a combination of two or more epoxy resins may be used.

Among these second epoxy resins, a bisphenol A-type epoxy resin and a bisphenol F-type epoxy resin are preferably used as the second epoxy resin, from the viewpoint of water resistance before complete curing of the coating film, and the anti-corrosion properties, impact resistance and adhesion to an underlying base (e.g., an existing coating film, a surface of an object to be painted) of the completely cured coating film. More preferably, the second epoxy resin contains a bisphenol A-type epoxy resin.

A epoxy equivalent of the second epoxy resin is preferably 150 to 1200, more preferably 150 to 1000. The epoxy equivalent of the second epoxy resin falling within the above-mentioned range is preferred, from the viewpoint of improvement in water resistance before complete curing of the coating film, and the water resistance, the anti-corrosion properties of the completely cured coating film and the like. By adjusting the epoxy equivalent of the second epoxy resin, characteristics of the water-borne paint composition and physical properties of the coating film can be controlled. The epoxy resin emulsion (B) is an emulsion of a second epoxy resin containing a bisphenol A-type epoxy resin preferably having an epoxy equivalent of 150 to 1200, more preferably 150 to 1000.

The number average molecular weight of the second epoxy resin is preferably 300 to 3000, more preferably 300 to 2500, in terms of standard polystyrene as determined by GPC. The number average molecular weight of the second epoxy resin falling within the above-mentioned range is advantageous from the viewpoint of improvement in water resistance before complete curing of the coating film, and impact resistance, water resistance, anti-corrosion properties and adhesion to an underlying base (e.g., an existing coating film, a surface of an object to be painted) of the completely cured coating film. By adjusting the molecular weight of the second epoxy resin, characterictics of the water-borne paint composition and physical properties of the coating film can be controlled.

The forcibly emulsified epoxy resin emulsion (B) can be produced by stirring and emulsifying the second epoxy resin together with an emulsifying agent in an aqueous medium (e.g., water). Specific examples of the emulsifying agent include a polyoxyethylene alkyl phenol ether-type nonionic surfactant, a polyether (e.g., a polyoxyethylene-polyoxypropylene block copolymer) and an adduct of at least one of the aforementioned nonionic surfactant and the polyether with a diisocyanate compound. Only one type of emulsifying agent may be used, or a combination of two or more types of emulsifying agents may be used.

The epoxy resin emulsion (B) prepared using a self-emulsifying second epoxy resin can be produced by emulsifying a resin produced by introducing a hydrophilic moiety into the above-mentioned epoxy resin in an aqueous medium such as water. Specific examples of the hydrophilic moiety include a side chain having a hydroxyl group or a carboxyl group, and a nonionic polyalkylene oxide skeleton.

The epoxy resin emulsion (B) may contain a pH modifier. As the pH modifier, an inorganic acid or an organic acid can be used. Specific examples of the inorganic acid include hydrochloric acid, sulfuric acid, nitric acid and phosphoric acid. Specific examples of the organic acid include formic acid and acetic acid. Only one type of pH modifier may be used, or a combination of two or more types of pH modifiers may be used.

Among these pH modifiers, phosphoric acid is used preferably. When the pH value of the epoxy resin emulsion (B) is adjusted to preferably less than 5, more preferably less than 4.5 using phosphoric acid, the anti-corrosion properties of the coating film can be improved. It is considered that this is because a passive film is formed on a surface of an object to be painted.

From the viewpoint of curability of the water-borne paint composition, water resistance before complete curing of the coating film, and impact resistance, water resistance, anti-corrosion properties of the completely cured coating film and the like, the content of the epoxy resin emulsion (B) in terms of solid content is preferably 3 to 50% by mass, more preferably 5 to 40% by mass (e.g., 5 to 30% by mass), relative to the total solid content in the water-borne paint composition.

### <Emulsion (C) of Non-Curable Resin>

The water-borne paint composition according to the present invention can further contain an emulsion (C) of a non-curable resin (hereinafter, the emulsion (C) is also referred to as “a non-curable resin emulsion (C)). The non-curable resin emulsion (C) may be contained in the first agent or may be contained in the second agent. The non-curable resin emulsion (C) may be added to the first agent or the second agent prior to mixing of the first agent with the second agent, or may be added after mixing of the first agent with the second agent. When the non-curable resin emulsion (C) is contained, adhesion to an underlying base, particularly an existing coating film, can be further improved. The improvement in adhesion to an underlying base leads to improvement in anti-corrosion properties of the coating film. When the non-curable resin emulsion (C) is contained, flexibility of the completely cured coating film can be improved and impact resistance of the completely cured coating film can also be improved. Only one type of non-curable resin emulsion (C) may be used, or a combination of two or more types of non-curable resin emulsions (C) may be used.

The term “non-curable resin” as used herein refers to a thermoplastic resin that does not have a curable functional group capable of curing-reacting with an amino group of the water-borne epoxy-based amine resin (A) or with an epoxy group or the second epoxy resin in the epoxy resin emulsion (B). Specific examples of the curable functional group include an amino group, an epoxy group, an isocyanate group and a (meth)acryloyl group.

The non-curable resin emulsion (C) may be an emulsion polymerization product produced by the emulsion polymerization of at least one monomer having no curable functional groups and having a polymerizable unsaturated bond (unsaturated double bond) in the presence of an emulsifying agent and a radical polymerization initiator. The monomer is generally a monomer having one polymerizable unsaturated bond in a molecule thereof. As the monomer, the following monofunctional vinyl compounds can be used.

An olefin compound such as ethylene, propylene, 1-butene and 1-hexene; a (meth)acrylic compound such as methyl (meth)acrylate, ethyl (meth)acrylate, n-propyl (meth)acrylate, t-butyl (meth)acrylate, isobutyl (meth)acrylate, ethylhexyl (meth)acrylate, ethoxyethyl (meth)acrylate, butoxyethyl (meth)acrylate, cyclohexyl mono(meth)acrylate, 2-hydroxyethyl (meth)acrylate, (meth)acrylic acid, (meth)acrylonitrile and N-isopropyl (meth)acrylamide; a styrene compound such as styrene and α-methylstyrene; a vinyl ester compound such as vinyl acetate, vinyl propionate and vinyl benzoate; and a halogenate vinyl compound such as vinyl chloride and vinylidene chloride. As the monomer to be subjected to the emulsion polymerization, only one monomer may be used, or a combination of two or more monomers may be used.

Among these non-curable resin emulsions (C), an emulsion of a copolymer that contains ethylene and vinyl acetate as monomer units, i.e., an ethylene-vinyl acetate copolymer (EVA) is preferred, from the viewpoint of adhesion to an underlying base and impact resistance of the coating film. From the viewpoint of adhesion to an underlying base and impact resistance of the coating film, the ethylene content ratio in EVA is preferably 5 to 50% by mass, more preferably 5 to 40% by mass (e.g., 10 to 30% by mass). Therefore, the vinyl acetate content ratio in EVA is preferably 50 to 95% by mass, more preferably 60 to 95% by mass (e.g., 70 to 90% by mass). The concentration of a solid matter in the non-curable resin emulsion (C) is, for example, 20 to 60% by mass.

From the viewpoint of adhesion to an underlying base and impact resistance of the coating film, the content of the non-curable resin emulsion (C) in terms of solid content is preferably 2 to 40% by mass, more preferably 3 to 30% by mass (e.g., 5 to 20% by mass), relative to the total solid content in the water-borne paint composition.

### <Alkoxysilane Compound (D)>

The water-borne paint composition according to the present invention can further contain an alkoxysilane compound (D). The alkoxysilane compound (D) may be contained in the first agent, or may be contained in the second agent. The alkoxysilane compound (D) may be added to the first agent or the second agent prior to mixing of the first agent with the second agent, or may be added after mixing of the first agent with the second agent. When the alkoxysilane compound (D) is contained, adhesion to an underlying base (e.g., an existing coating film, a surface of an object to be painted) can be further improved. The improvement in adhesion to an underlying base can lead to improvement in anti-corrosion properties of the coating film.

The alkoxysilane compound (D) has both of a functional group having reactivity with or affinity for an organic substance and a functional group having reactivity with or affinity for an inorganic substance. Specific examples of the functional group having reactivity with or affinity for an organic substance include a vinyl group, an epoxy group, a (meth)acrylic group, an amino group and a mercapto group. Specific examples of the functional group having reactivity with or affinity for an inorganic substance include alkoxysilane groups such as a methoxysilane group, an ethoxysilane group and a propoxysilane group. Only one type of alkoxysilane compound (D) may be used, or a combination of two or more types of alkoxysilane compounds (D) may be used.

Specific examples of the alkoxysilane compound (D) include: a γ-glycidoxyalkyltrialkoxysilane such as γ-glycidoxypropyltrimethoxysilane, γ-glycidoxypropyltriethoxysilane and γ-glycidoxypropoxytrimethoxysilane; a γ-methacryloxyalkyltrialkoxysilane such as γ-methacryloxypropyltrimethoxysilane, γ-methacryloxypropyltriethoxysilane and γ-methacryloxypropoxytrimethoxysilane; a γ-aminopropyltrialkoxysilane such as γ-aminopropyltriethoxysilane and γ-aminopropyltripropoxysilane; and a N-phenyl-γ-aminoalkyltrialkoxysilane such as N-phenyl-γ-aminopropyltrimethoxysilane, N-phenyl-γ-aminopropyltriethoxysilane and N-phenyl-γ-aminopropyltripropoxysilane. Among these alkoxysilane compounds (D), γ-glycidoxyalkyltrialkoxysilane, γ-methacryloxyalkyltrialkoxysilane, γ-aminopropyltrialkoxysilane and N-phenyl-γ-aminoalkyltrialkoxysilane are preferred, and γ-glycidoxyalkyltrialkoxysilane, γ-methacryloxyalkyltrialkoxysilane and γ-aminopropyltrialkoxysilane are more preferred, and γ-glycidoxyalkyltrialkoxysilane and γ-methacryloxyalkyltrialkoxysilane are still more preferred.

The alkoxysilane compound (D) may be a compound in which a part of an alkoxysilane group is hydrolyzed and/or a compound in which a part of an alkoxysilane group is hydrolyzed and dehydration-condensed.

The content of the alkoxysilane compound (D) is preferably 0.2 to 10% by mass, more preferably 0.5 to 7% by mass (e.g., 1 to 6% by mass), relative to the total solid content in the water-borne paint composition. When the content of the alkoxysilane compound (D) falls within the above-mentioned range, it becomes possible to produce a water-borne paint composition that can be formed into a coating film having excellent adhesion to an underlying base and therefore exhibiting excellent anti-corrosion properties. If the content of the alkoxysilane compound (D) is too large, curability of the coating film may be deteriorated.

### <Other Compounding Components (E)>

The water-borne paint composition according to the present invention can contain another compounding component other than the above-mentioned components, as required. Examples of another compounding component include a pigment, an additive, water and an organic solvent. Another compounding component may be contained in the first agent, or may be contained in the second agent. Another compounding component may be added to the first agent or the second agent prior to mixing of the first agent with the second agent, or may be added after mixing of the first agent with the second agent.

Specific examples of the pigment include: a coloring pigment such as titanium oxide, yellow iron oxide, red iron oxide, carbon black, phthalocyanine blue, phthalocyanine green, azo red, quinacridone red and benzimidazolone yellow; an extender pigment such as calcium carbonate, barium sulfate, kaolin, clay, talc, mica, alumina and alum; and an anti-corrosive pigment such as aluminum tripolyphosphate, zinc phosphate and calcium phosphate. Only one type of pigment may be used, or a combination of two or more types of pigments may be used.

The concentration of the pigment in the water-borne paint composition is preferably 20 to 50% by volume, more preferably 25 to 45% by volume, still more preferably 30 to 40% by volume. If the concentration of the pigment is less than 20% by volume, the effects produced by the addition of the pigment (e.g., anti-corrosion properties (anti-rust properties), improvement in strength of the coating film) may not be developed sufficiently. If the concentration of the pigment is more than 50% by volume, the appearance of the coating film may be deteriorated. The concentration by volume of the pigment can be determined by calculation from the amount of the pigment added and the specific gravities of the components in the paint.

Specific examples of the additive include a dispersant, a viscosity modifier, a curing catalyst, a surface modifier, an antifoaming agent, a plasticizer, a film formation aid, an ultraviolet ray absorber, an antioxidant agent, a leveling agent, a sedimentation inhibitor, an anti-corrosion agent, a reactive diluent and a non-reactive diluent. Only one type of additive may be used, or a combination of two or more types of additives may be used.

Specific examples of the solvent include: a glycol-type solvent such as ethylene glycol, propylene glycol, ethylene glycol monobutyl ether, propylene glycol monobutyl ether, diethylene glycol, dipropylene glycol, diethylene glycol monobutyl ether, dipropylene glycol monobutyl ether and diethylene glycol dibutyl ether; an aromatic solvent such as xylene, Solvesso 100, Solvesso 150 and Solvesso 200; a hydrocarbon-type solvent such as a Mineral Spirit; and an ester-type solvent such as 2,2,4-trimethyl-1,3-pentanediol monoisobutyrate, 2,2,4-trimethyl-1,3-pentanediol diisobutyrate, diethyl adipate and diisobutyl adipate.

### <Painting of Water-Borne Paint Composition>

The water-borne paint composition according to the present invention is painted onto an object of interest after mixing of the first agent with the second agent. The material of a surface of an object to be painted may be, for example, a metal (including an alloy thereof), a woody material, a plastic material, a rubber, a stone material, slate, concrete, mortar, a fiber, paper, glass, a ceramic, a pottery, a film and a complex thereof. For example, when the surface of an object to be painted is made from an inorganic material such as slate and concrete, a sealer may be applied onto the surface in advance. The surface of an object to be painted may have an existing coating film formed thereon. The water-borne paint composition according to the present invention is preferably applied onto a metal surface or an existing coating film or both of a metal surface and an existing coating film. Specific examples of the metal include iron, copper, tin, zinc, aluminum and a stainless steel.

Specific examples of the object of which the surface to be painted is a metal or an existing coating film include a building (e.g., a civil engineering structure), a ship, a vehicle (e.g., a railway vehicle, a heavy vehicle), an airplane, a bridge, a marine structure, a plant, a tank (e.g., a petroleum tank), a pipe, a steel pipe and a cast iron pipe.

A coating film can be produced by applying the water-borne paint composition onto an object of interest and then drying the applied water-borne paint composition. A method for the application may be selected appropriately depending on the type of the object to be painted (e.g., a base material) and the like. For example, coating using a brush, a roller, an air spray, an airless spray, a trowel or the like, dipping and the like can be employed.

The amount of the water-borne paint composition to be applied may vary depending on the intended use, the type of the object to be applied and the like, and is, for example, 10 to 350 g/m². The thickness of a dried coating film is, for example, 10 to 300 μm and may be 10 to 250 μm or 15 to 200 μm. The water-borne paint composition may be applied multiple times to form a dried coating film having a desired thickness. In this case, a dried coating film having a desired thickness may be formed by applying the water-borne paint composition multiple times to form multiple layers of wet coating films and then drying the wet coating films, or a dried coating film having a desired thickness may be formed by forming multiple layers of dried coating films.

The drying of the coating film can be performed by air-drying. The air-drying can be performed at ambient temperature (25° C. or a temperature around 25° C.) or a temperature lower than ambient temperature. In the case where air-drying is employed, a drying time required for obtaining a completely cured coating film is preferably 24 hours or longer, more preferably 1 week or longer. According to the water-borne paint composition of the present invention, a coating film having excellent water resistance before complete curing and a completely cured coating film having excellent water resistance and anti-corrosion properties can be formed even by carrying out the air-drying at ambient temperature or a temperature lower than ambient temperature.

It is possible to form another coating film prior to and/or after the formation of a coating film by applying the water-borne paint composition according to the present invention. In one embodiment, the water-borne paint composition according to the present invention is painted to form a coating film and then a top coat paint is painted on the coating film to form a top coat layer. When a top coat layer is formed, the appearance, anti-corrosion properties and water resistance can be further improved.

Specific examples of the top coat paint include an epoxy/amine-based paint, a two-pack paint with urethane curing system, a one-pack paint with urethane curing system, a paint with carbodiimide curing system, an acrylic resin based paint, an alkyd resin based paint and a silicone resin based paint. The top coat paint may be of a solvent-borne type or a water-borne type. From the viewpoint of reduction in environmental impact, the top coat paint is preferably of a water-borne type. The top coat paint is more preferably a water-borne two-pack paint with urethane curing system, a water-borne one-pack paint with urethane curing system, a water-borne silicone resin based paint, and a water-borne paint with carbodiimide curing system. When these water-borne paints are used, excellent weather resistance and long-lasting protection of beautiful appearance can be achieved.

The top coat layer can be formed by applying the top coat paint and then drying the applied top coat paint. A method for the application may be selected appropriately depending on the type of the top coat paint and the like. For example, coating using a brush, a roller, an air spray, an airless spray, a trowel or the like, dipping and the like can be employed.

The amount of the top coat paint to be applied may vary depending on the type of the paint, the purpose of the painting and the like, and is, for example, 30 to 400 g/m². The thickness of a dried top coat layer is, for example, 10 to 500 μm, and may be 10 to 300 μm or 10 to 150 μm. The drying of the coating film made from the top coat paint can be performed by air-drying, forced drying, baking or the like.

Prior to the formation of the coating film with the water-borne paint composition according to the present invention, an under coat paint may be applied on a surface of the object to be painted to form an under coat layer. When the under coat layer is formed, excellent anti-corrosion properties and water resistance can be achieved and the requirements for high anti-corrosion properties in a bridge, a plant, a tank or the like can be satisfied sufficiently.

The under coat paint is, for example, an organic or inorganic zinc-rich paint. The under coat paint may be of a solvent-borne type or a water-borne type. From the viewpoint of reduction in environmental impact, the under coat paint is preferably of a water-borne type.

For the formation of the under coat layer, the same method as that employed for the formation of the top coat layer can be employed. The amount of the under coat paint to be applied may vary depending on the type of the paint, the purpose of the painting and the like, and is, for example, 80 to 1200 g/m². The thickness of a dried under coat layer is, for example, 20 to 300 μm, and may be 20 to 200 μm. The drying of the coating film made from the under coat paint can be performed by air-drying, forced drying, baking or the like.

After the application of the water-borne paint composition according to the present invention to form the coating film, it is possible to apply an intermediate coat paint on the coating film to form an intermediate coat layer. When the intermediate coat layer is formed, a coating film having excellent anti-corrosion properties and water resistance can be produced. It is preferred to form the top coat layer on the intermediate coat layer.

Examples of the intermediate coat paint include an epoxy/amine-based paint, a two-pack paint with urethane curing system and a one-pack paint with urethane curing system. The intermediate coat paint may be of a solvent-borne type or of a water-borne type. From the viewpoint of reduction in environmental impact, the intermediate coat paint is preferably of a water-borne type. The intermediate coat paint is more preferably a water-borne epoxy/amine-based paint or a water-borne two-pack paint with urethane curing system. When a water-borne paint of this type is used, a stiff multi-layer coating film having good cohesiveness to the top coat layer can be formed.

For the formation of the intermediate coat layer, the same method as that employed for the formation of the top coat layer can be employed. The amount of the intermediate coat paint to be applied may vary depending on the type of the paint, the purpose of the painting and the like, and is, for example, 20 to 400 g/m². The thickness of a dried intermediate coat layer is, for example, 10 to 200 μm, and may be 10 to 100 μm.

Each of the top coat paint, the intermediate coat paint and the under coat paint can contain a pigment, an additive or the like. Specific examples of the pigment, the additive and the like are as mentioned for the water-borne paint composition according to the present invention.

### EXAMPLES

Hereinbelow, the present invention will be described in more detail by way of Examples and Comparative Examples. However, the present invention is not intended to be limited by the following examples. In the following examples, all parts are by mass and all percents (%) are by mass unless otherwise specified.

[1] Production of Water-Borne Paint Compositions

### Production Example 1: Preparation of Water-Borne Epoxy-Based Amine Resin (A) I

Into a reaction vessel equipped with a stirrer, a condenser, a nitrogen inlet tube and a thermometer were introduced 513 parts of a raw material resin that was synthesized from bisphenol A and epichlorohydrin and had an epoxy equivalent of 188 g/equivalent, 197 parts of bisphenol A and 180 parts of methyl isobutyl ketone (also referred to as “MIBK”, hereinafter). The components were reacted with one another at 117° C. in the presence of 1 part of benzyldimethylamine until the epoxy equivalent became 730 g/equivalent to produce an epoxy resin. Subsequently, 360 parts of a ketimine compound of diethylenetriamine (73% by mass, a solution in MIBK) was added to the reaction mixture, and the resultant mixture was reacted at 117° C. for 1 hour. Subsequently, 27 parts of ion-exchanged water and 190 parts of glycidyl neodecanoate ester (a product manufactured by Hexion Specialty Chemicals Inc., product name: “CARDURA E10-P”) were introduced into the reaction vessel, and the resultant mixture was reacted at 100° C. for 2 hours. Subsequently, the resultant mixture was diluted with MIBK until a non-volatile matter content became 75% to produce an epoxy-based amine resin having an amine equivalent of 810. Subsequently, acetic acid was added to the mixture so that the above-defined neutralization ratio became 35%, and then the resultant mixture was diluted with ion-exchanged water. Subsequently, a mixture of MIBK and water was removed from the mixture under reduced pressure until a solid content became 40% by mass to produce a milky white water-borne (water dispersion type) epoxy-based amine resin (A) I. The amine equivalent of the water-borne epoxy-based amine resin (A) I was calculated from the amount of the raw material compounded.

### Production Example 2: Preparation of Water-Borne Epoxy-Based Amine Resin (A) II

Into a reaction vessel equipped with a stirrer, a condenser, a nitrogen inlet tube and a thermometer were introduced 742 parts of a raw material resin that was synthesized from bisphenol A and epichlorohydrin and had an epoxy equivalent of 188 g/equivalent, 336 parts of bisphenol A and 190 parts of methyl isobutyl ketone (also referred to as “MIBK”, hereinafter). The components were reacted with one another at 117° C. in the presence of 1 part of benzyldimethylamine until the epoxy equivalent became 1079 g/equivalent to produce an epoxy resin. Subsequently, 360 parts of a ketimine compound of diethylenetriamine (73% by mass, a solution in MIBK) was added to the reaction mixture, and the resultant mixture was reacted at 117° C. for 1 hour. Subsequently, 27 parts of ion-exchanged water and 188 parts of glycidyl neodecanoate ester (a product manufactured by Hexion Specialty Chemicals Inc., product name: “CARDURA E10-P”) were introduced into the reaction vessel, and the resultant mixture was reacted at 100° C. for 2 hours. Subsequently, the resultant mixture was diluted with MIBK until a non-volatile matter content became 75% to produce an epoxy-based amine resin having an amine equivalent of 1095. Subsequently, acetic acid was added to the mixture so that the above-defined neutralization ratio became 35%, and then the resultant mixture was diluted with ion-exchanged water. Subsequently, a mixture of MIBK and water was removed from the mixture under reduced pressure until a solid content became 40% by mass to produce a milky white water-borne (water dispersion type) epoxy-based amine resin (A) II. The amine equivalent of the water-borne epoxy-based amine resin (A) II was calculated from the amount of the raw material compounded.

### Production Example 3: Preparation of Water-Borne Epoxy-Based Amine Resin (A) III

Into a reaction vessel equipped with a stirrer, a condenser, a nitrogen inlet tube and a thermometer were introduced 1940 parts of a raw material resin that was synthesized from bisphenol A and epichlorohydrin and had an epoxy equivalent of 188 g/equivalent, 1060 parts of bisphenol A and 1000 parts of methyl isobutyl ketone (also referred to as “MIBK”, hereinafter). The components were reacted with one another at 117° C. in the presence of 8 parts of benzyldimethylamine until the epoxy equivalent became 3000 g/equivalent to produce an epoxy resin. Subsequently, 360 parts of a ketimine compound of diethylenetriamine (73% by mass, a solution in MIBK) was added to the reaction mixture, and the resultant mixture was reacted at 117° C. for 1 hour. Subsequently, the resultant mixture was diluted with MIBK until a non-volatile matter content became 60% to produce an epoxy-based amine resin having an amine equivalent of 1550. Subsequently, acetic acid was added to the mixture so that the above-defined neutralization ratio became 40%, and then the resultant mixture was diluted with ion-exchanged water. Subsequently, a mixture of MIBK and water was removed from the mixture under reduced pressure until a solid content became 40% by mass to produce a milky white water-borne (water dispersion type) epoxy-based amine resin (A) III. The amine equivalent of the water-borne epoxy-based amine resin (A) III was calculated from the amount of the raw material compounded.

### Production Example 4: Preparation of Water-Borne Epoxy-Based Amine Resin (A) IV

Into a reaction vessel equipped with a stirrer, a condenser, a nitrogen inlet tube and a thermometer were introduced 2190 parts of a raw material resin that was synthesized from bisphenol A and epichlorohydrin and had an epoxy equivalent of 188 g/equivalent, 1210 parts of bisphenol A and 1150 parts of methyl isobutyl ketone (also referred to as “MIBK”, hereinafter). The components were reacted with one another at 117° C. in the presence of 8 parts of benzyldimethylamine until the epoxy equivalent became 3400 g/equivalent to produce an epoxy resin. Subsequently, 360 parts of a ketimine compound of diethylenetriamine (73% by mass, a solution in MIBK) was added to the reaction mixture, and the resultant mixture was reacted at 117° C. for 1 hour. Subsequently, the resultant mixture was diluted with MIBK until a non-volatile matter content became 60% to produce an epoxy-based amine resin having an amine equivalent of 1750. Subsequently, acetic acid was added to the mixture so that the above-defined neutralization ratio became 45%, and then the resultant mixture was diluted with ion-exchanged water. Subsequently, a mixture of MIBK and water was removed from the mixture under reduced pressure until a solid content became 40% by mass to produce a milky white water-borne (water dispersion type) epoxy-based amine resin (A) IV. The amine equivalent of the water-borne epoxy-based amine resin (A) IV was calculated from the amount of the raw material compounded.

### Production Example 5: Preparation of Epoxy-Based Amine Resin V

Into a reaction vessel equipped with a stirrer, a condenser, a nitrogen inlet tube and a thermometer were introduced 2750 parts of a raw material resin that was synthesized from bisphenol A and epichlorohydrin and had an epoxy equivalent of 188 g/equivalent, 1550 parts of bisphenol A and 1800 parts of methyl isobutyl ketone (also referred to as “MIBK”, hereinafter). The components were reacted with one another at 117° C. in the presence of 10 parts of benzyldimethylamine until the epoxy equivalent became 4300 g/equivalent to produce an epoxy resin. Subsequently, 360 parts of a ketimine compound of diethylenetriamine (73% by mass, a solution in MIBK) was added to the reaction mixture, and the resultant mixture was reacted at 117° C. for 1 hour. Subsequently, the resultant mixture was diluted with MIBK until a non-volatile matter content became 60% to produce an epoxy-based amine resin having an amine equivalent of 2200. Subsequently, acetic acid was added to the mixture so that the above-defined neutralization ratio became 50%, and then the resultant mixture was diluted with ion-exchanged water. Subsequently, a mixture of MIBK and water was removed from the mixture under reduced pressure until a solid content became 40% by mass to produce an epoxy-based amine resin V. This epoxy-based amine resin was not rendered water-borne, and caused phase separation in water. The amine equivalent of the epoxy-based amine resin V was calculated from the amount of the raw material compounded.

The amine equivalents, number average molecular weights in terms of standard polystyrene as measured by GPC and states of the water-borne epoxy-based amine resins (A) and the epoxy-based amine resin produced in Production Examples, the the epoxy equivalents of the epoxy resins that formed the water-borne epoxy-based amine resins (A) and the epoxy-based amine resin and others are summarized in Table 1.

TABLE 1

| | Production Example | | | | |
|---|---|---|---|---|---|
| | 1 | 2 | 3 | 4 | 5 |
| Water-borne epoxy-based amine resin | I | II | III | IV | V |
| (A) No. or epoxy-based amine resin No. | | | | | |
| Neutralization ratio (%) | 35 | 35 | 40 | 45 | 50 |
| Solid content (% by mass) | 40 | 40 | 40 | 40 | 40 |
| Amine equivalent | 810 | 1095 | 1550 | 1750 | 2200 |
| Number average molecular weight | 1500 | 2300 | 6200 | 7000 | 9000 |
| (GPC) | | | | | |
| Epoxy equivalent of | 730 | 1079 | 3000 | 3400 | 4300 |
| epoxy resin | | | | | |
| State | Water | Water | Water | Water | Phase- |
| | dispersion | dispersion | dispersion | dispersion | separated |
| | type | type | type | type | |

### Production Example 6: Preparation of Emulsion IX Containing Compound Having (Meth)Acryloyl Group

35 parts of water, 10 parts of dipropylene glycol monobutyl ether, 5 parts of a nonionic emulsifying agent [a product manufactured by Nippon Nyukazai Co., Ltd., product name: “Newcol 740”] and 50 parts of propoxylated trimethylolpropane triacrylate (PO 3 mol) [viscosity (25° C.): 85 mPa·s, molecular weight: 470, number of functional groups: 3, acryloyl group equivalent: 157] were mixed together, and the resultant mixture was stirred with a homogenizer for 10 minutes to produce an emulsion IX that contained a compound having a (meth)acryloyl group. The term “PO 3 mol” means that there are three propylene oxide moieties in a molecule thereof.

### Examples 1 to 7, Comparative Example 1

80 parts of water, 25 parts of a pigment dispersant (a product manufactured by BYK-Chemie, product name: “Disperbyk-190”), 75 parts of talc, 40 parts of calcium carbonate, 170 parts of titanium oxide and 20 parts of a phosphate-type anti-corrosive pigment were mixed together, and the resultant mixture was stirred using a disper for 30 minutes to produce a pigment-dispersed paste. Subsequently, compounding components for a first agent (a main agent) shown in Table 2 (in compounding amounts shown in Table 2) and 410 parts of the above-produced pigment-dispersed paste were mixed together using a disper. Subsequently, 50 parts of dipropylene glycol monobutyl ether and 5 parts of an associative thickener (a product manufactured by ADEKA Corporation, product name: “ADEKA NOL UH-420”) were added to and mixed with the mixture to prepare a first agent (a main agent).

Compounding components for a second agent shown in Table 2 in amounts shown in Table 2 were mixed together using a disper to prepare a second agent, or a compounding component for a second agent shown in Table 2 was used without any modification as a second agent (a curing agent). In this manner, two-pack water-borne paint compositions were produced. The unit for each of the compounding amounts shown in Table 2 is “part(s) by mass”. Each of the compounding amounts shown in Table 2 is not an amount in terms of a solid content but a net weight. The details of the abbreviations of the compounding components shown in Table 2 are as follows.

(a) Water-based epoxy-based amine resin VI: “Fujicure FXS-918-FA” (an epoxy adduct-type modified polyamine resin, solid content: 60% by mass, amine equivalent: 387) manufactured by T&K TOKA Corporation,

(b) Non-curable resin emulsion (C) VII: “Polysol AD-18” (an emulsion of an ethylene-vinyl acetate copolymer (EVA), solid content: 56% by mass, ethylene content ratio: 20% by mass) manufactured by Showa Denko K. K.,

(c) Epoxy resin emulsion (B) VIII: “ADEKA RESIN EM-101-50” (an emulsion of a bisphenol A-type epoxy resin, solid content: 47% by mass, epoxy equivalent: 500 g/equivalent, number average molecular weight: 1000) manufactured by ADEKA corporation, and

(d) Alkoxysilane compound (D) X: “Dynasylan GLYMO” (3-glycidoxypropyltrimethoxysilane, solid content: 100% by mass) manufactured by EVONIK INDUSTRIES.

[2] Assessment of Water-Borne Paint Compositions

The water-borne paint compositions thus produced were assessed by the following methods. The results are shown in Table 2.

(Water Resistance Before Complete Curing of Coating Films)

The first agent and the second agent for each of two-pack water-borne paint compositions were mixed together using a disper, and the resultant mixture was applied onto a polished steel plate in an application amount of 200 g/m² using a brush and was then dried under the environment of 5° C. for 24 hours to produce a test plate having a coating film that was not completely cured. The test plate was immediately dipped in water at 5° C., and was drawn up after the lapse of 24 hours. The test plate was allowed to leave at 5° C. for 24 hours, and then the appearance of the test plate was observed with naked eyes to be assessed based on the following criteria.

AA: No defect in appearance was observed.

A: Slight change in gloss/color was observed, but no trace of cracking or blistering was observed.

C: Traces of cracking or blistering were observed.

(Adhesion of Coating Films to Existing Coating Films)

A polished steel plate was used as a base. “Hipon Fine Primer II” (a product manufactured by Nippion Paint Co., Ltd.) was applied, as an anti-corrosive paint, onto the polished steel plate using an air spray at a dried film thickness of 50 μm, and then dried for 1 day. “Fine Urethane U100” (a product manufactured by Nippon Paint Co., Ltd.) was applied onto the film formed form the anti-corrosive paint using a brush at a dried film thickness of 60 μm. Subsequently, the resultant product was aged for 3000 hours by an accelerated weather resistance method (a xenon arc lamp method) in accordance with JIS K 5600-7-7 to produce an existing (old) coating film. Subsequently, the first agent and the second agent for a two-pack water-borne paint composition were mixed together using a disper, and the resultant mixture was applied onto the existing coating film using a brush in an application amount of 200 g/m². The resultant product was dried under the environment of 23° C. for 168 hours to produce a test plate having a coating film made from the water-borne paint composition. The test plate was subjected to an adhesion test by a cross-cut method in accordance with JIS K 5600-5-6, and was then assessed based on the following criteria.

0: Cut edges were completely smooth, and delamination was not observed in any grid.

1: Slight delamination of a coating film was observed at intersections of cut lines, and the area of delaminated parts was less than 5%.

2: The area of delaminated parts was greater than or equal to 5% and less than 15%.

3: The area of delaminated parts was greater than or equal to 15% and less than 35%.

4: The area of delaminated parts was greater than or equal to 35% and less than 65%.

5: The area of delaminated parts was greater than or equal to 65%.

(Impact Resistance (Falling Weight Resistance Test) of Coating Films)

A falling weight resistance test was carried out using weights having masses of 300 g and 500 g, respectively, by the DuPont method in accordance with JIS K 5600-5-3, and the assessment was carried out based on the following criteria. In this test, the weight falling height was 500 mm.

A: A coating film did not undergo cracking or delamination.

B: A coating film underwent cracking or delamination.

TABLE 2

| | | | | | | | | | | Comparative |
|---|---|---|---|---|---|---|---|---|---|---|
| | | | Example | | | | | | | Example |
| | | | 1 | 2 | 3 | 4 | 5 | 6 | 7 | 1 |
| First | Water-borne | I | | | 81 | | | | | |
| agent | epoxy-based amine | (Amine equivalent | | | | | | | | |
| | resin (A) | 810) | | | | | | | | |
| | | II | 403 | | | 322 | 322 | 322 | 403 | |
| | | (Amine equivalent | | | | | | | | |
| | | 1095) | | | | | | | | |
| | | III | | 403 | | 81 | 81 | 81 | | |
| | | (Amine equivalent | | | | | | | | |
| | | 1550) | | | | | | | | |
| | | IV | | | 322 | | | | | |
| | | (Amine equivalent | | | | | | | | |
| | | 1750) | | | | | | | | |
| | | VI | | | | | | | | 403 |
| | | (Amine equivalent | | | | | | | | |
| | | 387) | | | | | | | | |
| | Non-curable resin | VII | | | | | 23 | | | |
| | emulsion (C) | | | | | | | | | |
| Second | Epoxy resin | VIII | 148 | 148 | 148 | 148 | 148 | 148 | | 148 |
| agent | emulsion (B) | | | | | | | | | |
| | Emulsion | IX | | | | | | | 55 | |
| | Alkoxysilane | X | | | | | | 1.6 | | |
| | compound (D) | | | | | | | | | |
| Assessment | Water resistance before complete curing | | A | A | AA | AA | AA | AA | A | C |
| | Adhesion to existing coating film | | 1 | 1 | 1 | 1 | 0 | 0 | 4 | 3 |
| | Impact resistance, | 300 g | A | A | A | A | A | A | A | A |
| | falling weight | 500 g | A | A | A | A | A | A | B | B |
| | resistance | | | | | | | | | |

1. A two-pack air-drying type water-borne paint composition comprising a first agent and a second agent,
wherein the first agent contains a water-borne epoxy-based amine resin (A), the water-borne epoxy-based amine resin (A) having at least one amino group selected from the group consisting of a primary amino group and a secondary amino group in a molecule thereof and having an amine equivalent of 500 to 2000, and
the second agent contains an epoxy resin emulsion (B).

2. The air-drying type water-borne paint composition according to claim 1,
wherein the water-borne epoxy-based amine resin (A) is of a water dispersion type.

3. The air-drying type water-borne paint composition according to claim 1, wherein the water-borne epoxy-based amine resin (A) is an amine-modified product of an epoxy resin, and
the epoxy resin has an epoxy equivalent of 700 to 3800.

4. The air-drying type water-borne paint composition according to claim 1, wherein the water-borne epoxy-based amine resin (A) comprises a water-borne epoxy-based amine resin (A1) having an amine equivalent of 500 to 1300 and a water-borne epoxy-based amine resin (A2) having an amine equivalent of 1400 to 2000.

5. The air-drying type water-borne paint composition according to claim 4, wherein a mass ratio of the water-borne epoxy-based amine resin (A1) to the water-borne epoxy-based amine resin (A2) is 8/2 to 2/8.

6. The air-drying type water-borne paint composition according to claim 1, wherein the water-borne epoxy-based amine resin (A) is a neutralization product in which an amino group of an epoxy-based amine resin is neutralized with an acid.

7. The air-drying type water-borne paint composition according to claim 6, wherein a neutralization ratio in the neutralization is 20 to 60%.

8. The air-drying type water-borne paint composition according to claim 1, wherein the epoxy resin emulsion (B) is an emulsion of a bisphenol A-type epoxy resin having an epoxy equivalent of 150 to 1200.

9. The air-drying type water-borne paint composition according to claim 1, wherein at least one of the first agent and the second agent further contains an emulsion (C) of a non-curable resin.

10. The air-drying type water-borne paint composition according to claim 9, wherein the emulsion (C) of a non-curable resin is an emulsion polymerization product of a monomer having a polymerizable unsaturated bond.

11. The air-drying type water-borne paint composition according to claim 10, wherein the monomer having a polymerizable unsaturated bond comprises ethylene and vinyl acetate.

12. The air-drying type water-borne paint composition according to claim 1, wherein at least one of the first agent and the second agent further contains an alkoxysilane compound (D).

13. (canceled)
